(19) United States
(12) Patent Application Publication
(10) Pub. No.: US 2010/0018699 A1
(43) Pub. Date: Jan. 28, 2010

(54) Low Stress Threadform with a Non-conic Section Curve

(76) Inventors: David R. Hall, Provo, UT (US); Scott Dahlgren, Alpine, UT (US)

Correspondence Address: TYSON J. WILDE;NOVATEK INTERNATIONAL, INC., 2185 SOUTH LARSEN PARKWAY, PROVO, UT, 84606, US

(21) Appl. No.: 12/575,237

(22) Filed: Oct. 7, 2009

Related U.S. Application Data
(63) Continuation-in-part of application No. 11/947,949, filed on Nov. 30, 2007.
Application No. 11/947,949 is a continuation-in-part of application No. 11/841,101, filed on Aug. 20, 2007.
Application No. 11/841,101 is a continuation-in-part of application No. 11/688,952, filed on Mar. 21, 2007, now Pat. No. 7,497,254.

(51) Int. Cl. E21B 17/042; F16B 7/18; F16L 15/06

(52) U.S. Cl. 166/242.6; 403/343

(57) ABSTRACT

In one aspect of the present invention a threadform has a load bearing flank and a non-load bearing flank joined by a thread root. The load bearing flank tangentially joins the thread root at a first angle, and the non-load bearing flank joins the root to a second angle. The root is made of a single non-conic section curve.

### CROSS REFERENCE TO RELATED APPLICATIONS

This application is a continuation in part of U.S. patent application Ser. No. 11/947,949. This application is also a continuation in-part of U.S. patent application Ser. No. 11/841,101, which is a continuation in part of U.S. patent application Ser. No. 11/688,952. The abovementioned references are herein incorporated by reference for all that they contain.

### BACKGROUND OF THE INVENTION

The present invention relates to threadforms. Highly loaded threadforms often fail from fatigue with cracks initiating at the thread root. Most prior art threads include thread roots with radii of curvature, generally believing that a larger radius of curvature will yield a lower stress threadform. However, the prior art does include several references teaching that thread root curves defined by a portion of an ellipse advantages have over root threads formed by radii as taught in U.S. Pat. Nos. 4,799,844 to Chuang; 5,056,661 to Yousef, 5,060,740 to Yousef, 5,163,523 to Yousef, 5,544,993 to Harle; 5,736,658 to Harle; 7,210,710 to Williamson; and U.S. Patent Publication No. 2005/0189147 to Williamson. All of these references are herein incorporated by reference for all that they contain.

Both circles and ellipses are conic sections, meaning that they comprise a closed curvature defined by the intersection of a plane with a cone. In threadform prior art, curves are described as being defined by a portion of either a circle or an ellipse. Those threadforms defined by a portion of a circle have a constant radius of curvature.

### BRIEF SUMMARY OF THE INVENTION

In one aspect of the present invention a threadform has a load bearing flank and a non-load bearing flank joined by a thread root. The load bearing flank tangentially joins the thread root at a first angle, and the non-load bearing flank joins the root to a second angle. The root is made of a single non-conic curve. The sharpest section of the curve may be between a midpoint of the curve and the load bearing flank. The curve may have a constantly changing radius of curvature.

The first and second angles may be 55 to 65 degrees. In some embodiments, the threadform is an internal threadform or an external threadform and may be tapered.

In another aspect of the present invention, a threadform is formed on a tool string component. A load bearing flank and a non-load bearing flank are joined by a thread root. The load bearing flank tangentially joins the thread root at a first angle of 55 to 65 degrees and the non-load bearing flank joins the root at a second angle of less than 55 to 65 degrees. The root also has a single non-conic curve. The threadform may formed proximate an end of the tool string component or formed in between tool joints connected to ends of the tool string component.

### BRIEF DESCRIPTION OF THE DRAWINGS

FIG. 1 is a perspective view of an embodiment of a downhole tool string suspended in a well bore.

FIG. 2 is a cross sectional view of an embodiment of downhole tool string component.

FIG. 3 is a cross sectional view of an embodiment of a pin end connection.

FIG. 4 is a cross sectional view of an embodiment of a box end connection.

FIG. 5 is a cross sectional view of an embodiment of a threadform.

FIG. 6a is a cross sectional view of an embodiment of a thread root.

FIG. 6b is a diagram of an embodiment of a relationship between alternating stress and cycles of a threadform.

FIG. 7a is a cross sectional view of another embodiment of a thread root.

FIG. 7b is a cross sectional view of another embodiment of a thread root.

FIG. 8 is a cross sectional view of an embodiment of downhole tool string component.

### DETAILED DESCRIPTION OF THE INVENTION AND THE PREFERRED EMBODIMENT

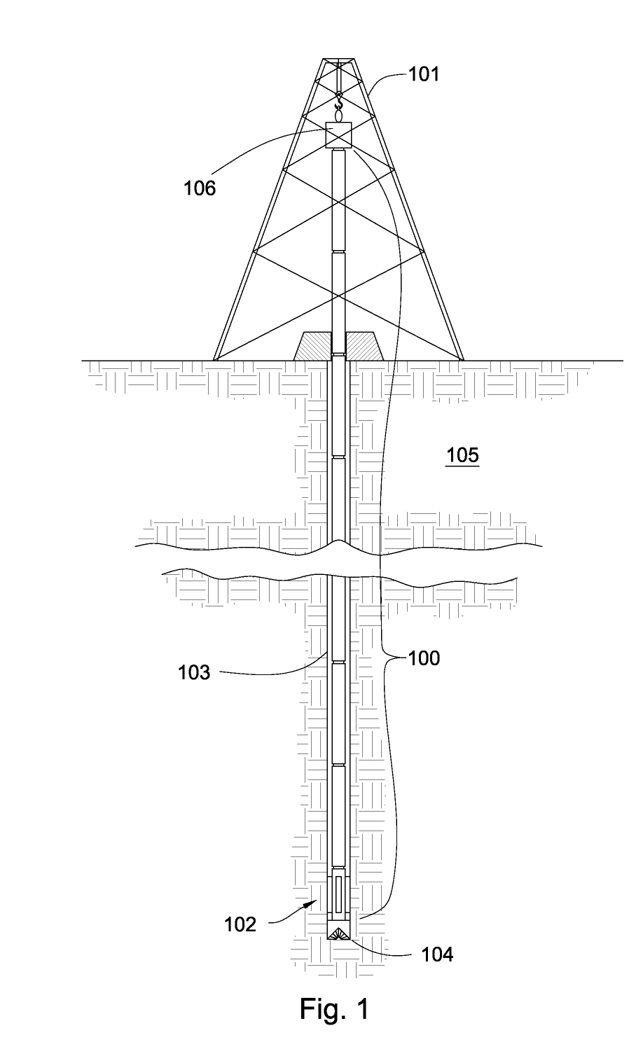

FIG. 1 discloses a drill string 100 suspended by a derrick 101 in a wellbore. A bottom-hole assembly 102 near the bottom of the well bore 103 and comprises a drill bit 104. As the drill bit 104 rotates downhole the drill string 100 advances farther into the earth. The drill string may penetrate soft or hard subterranean formations 105. The bottom hole assembly 102 and/or downhole components may comprise data acquisition devices which may gather data. The data may be sent to the surface via a transmission system to a data swivel 106. The data swivel 106 may send the data to the surface equipment. Further, the surface equipment may send data and/or power to downhole tools and/or the bottom-hole assembly 102. A preferred data transmission system is disclosed in U.S. Pat. No. 6,670,880 to Hall, which is herein incorporated by reference for all that it discloses. However, in some embodiments, no telemetry system to the surface is required. Mud pulse, short hop, or EM telemetry systems, or wired pipe may also be used with the present invention.

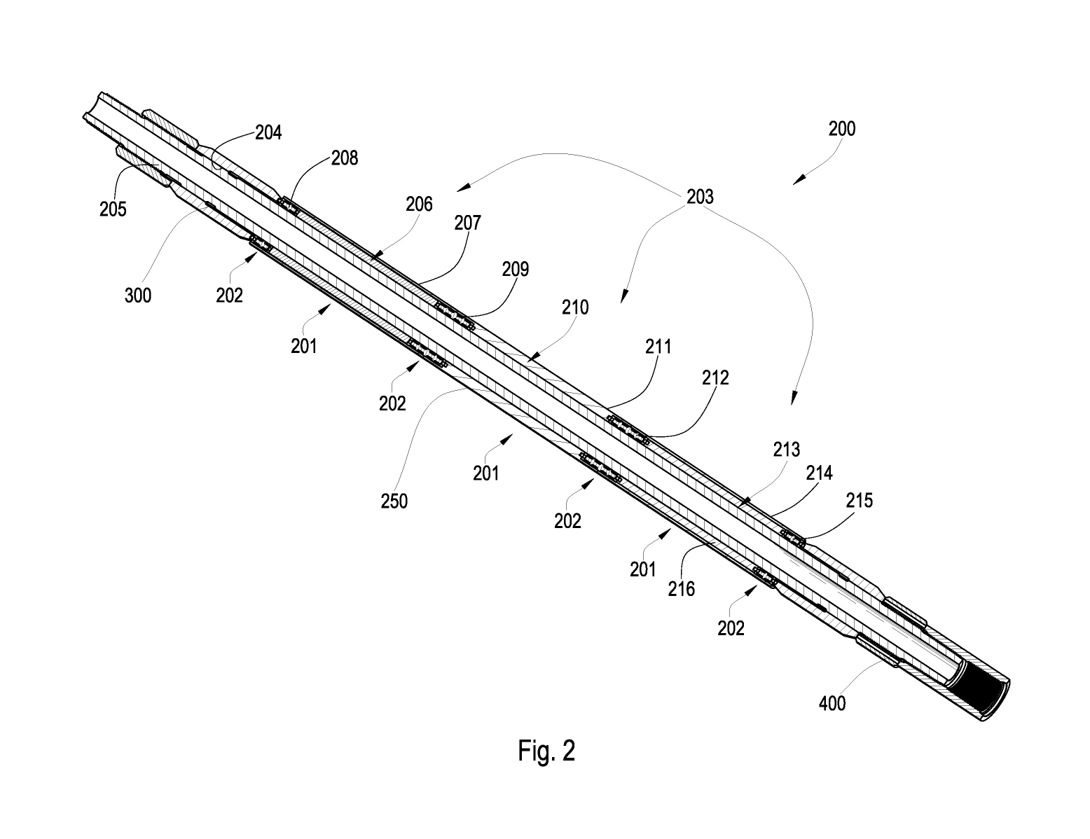

FIG. 2 discloses a downhole tool string component 200 in the drill string 100. The component comprise a plurality of pockets 201 are formed by a plurality of flanges 202 disposed around the component's circumference 250 at different axial locations and covered by individual sleeves 203 disposed between and around the flanges 202. A first pocket 206 may be formed around an outer diameter 204 of a tubular body 205 by a first sleeve 207 disposed around the tubular body 205 such that opposite ends of the first sleeve 207 fit around at least a portion of a first flange 208 and a second flange 209. A second pocket 210 may be formed around the outer diameter 204 of the tubular body 205 by a second sleeve 211 disposed around the tubular body 205 such that opposite ends of the second sleeve fit 211 around at least a portion of the second flange 209 and a third flange 212. A third pocket 213 may also be formed around the outer diameter 204 of the tubular body 205 by a third sleeve 214 disposed around the tubular body 205 such that opposite ends of the third sleeve 214 fit around at least a portion of the third flange 212 and a fourth flange 215. The sleeves 203 may be interlocked or keyed together near the flanges 202 for extra torsional support.

The individual sleeves 203 may allow for better axial and torsional flexibility of the component 200 than if the component 200 comprised a single sleeve spanning the pockets 201. However, in some embodiments of the present invention, a single sleeve is used. The sleeves 203 may also comprise a plurality of grooves adapted to allow the sleeves 203 to stretch and/or flex with the tubular body 205. At least one sleeve may be made of a nonmagnetic material, which may be useful in embodiments using magnetic sensors or other electronics. The pockets 201 may be sealed, though a sleeve and the pocket may comprise openings adapted to allow fluid to pass through the sleeve such that one of the pockets is a wet pocket.

Electronic equipment may be disposed within at least one of the pockets of the tool string component. The electronics may be in electrical communication with the aforementioned telemetry system, or they may be part of a closed-loop system downhole. An electronics housing 216 may be disposed within at least one of the pockets wherein the electronic equipment may be disposed, which may protect the equipment from downhole conditions. The electronics may comprise sensors for monitoring downhole conditions. The sensors may include pressure sensors, strain sensors, flow sensors, acoustic sensors, temperature sensors, torque sensors, position sensors, vibration sensors, geophones, hydrophones, electrical potential sensors, nuclear sensors, or any combination thereof. Information gathered from the sensors may be used either by an operator at the surface or by the closed-loop system downhole for modifications during the drilling process. If electronics are disposed in more than one pocket, the pockets may be in electrical communication, which may be through an electrically conductive conduit disposed within the flange separating them.

The shoulders formed by collars 300 and 400 may place the sleeves or sleeve, depending on the embodiment, in compression. In some embodiments, this compression may be enough to support the assembly in torsional and axial forces with the help of pins or fasteners.

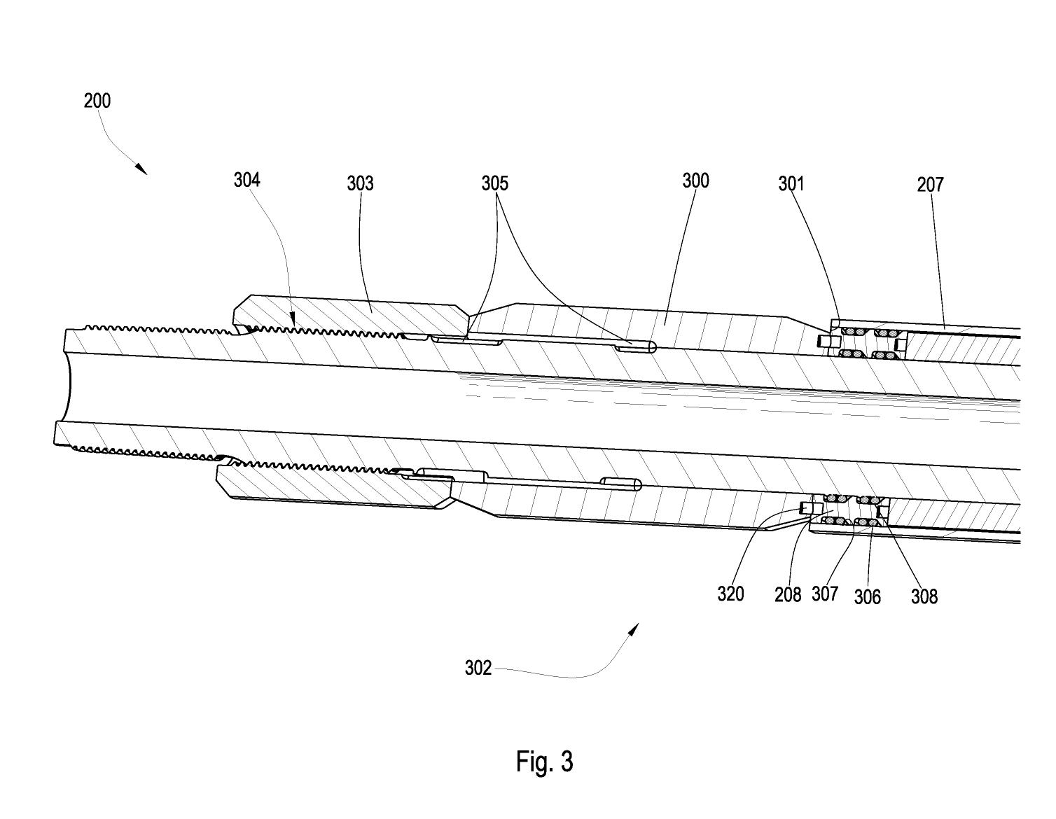

Referring now to FIG. 3, the first flange 208 may abut a first shoulder collar 300 disposed around the tubular body at a first end 302 of the tool string component 200. This collar 300 may be adapted to be a primary shoulder 301 of the component. The primary shoulder 301 may provide strength and stability for the component while downhole and may prevent the sleeves 203 and flanges 202 from experiencing axial movement with respect to the component. The first shoulder collar 300 may be supported by a first left-threaded collar 303, which may be disposed around the first end 302 on a left-threaded portion 304 of the component. The left-threaded collar 303 may be keyed to the component with pins 305 in order to keep the left-threaded collar 303 axially stationary and to provide axial support to the first shoulder collar 300.

The component 200 may be assembled at the drill site. The first shoulder collar 300 may be keyed to the component by a plurality of pins 305. The left-threaded collar 303 may be disposed around the component before the first shoulder collar 300 during assembly. After the left-threaded collar 303 is threaded on the component, the first shoulder collar 300 may then be slid into position from the opposite end of the component 200 over the plurality of pins 305 which keys the component to the component.

The flanges 202 may then be placed around the component, with the first flange 208 being keyed to the primary shoulder 301, possibly by another plurality of pins 320, in order to keep the first flange 208 rotationally stationary and provide torsional support. The flanges 202 may comprise O-rings 306 disposed around an outer diameter 307 of the flanges and/or within an inner diameter 308 of the flanges 202, such that the pockets 201 may be sealed when the sleeves 203 are placed around the component. The first sleeve 207 may abut a portion of the primary shoulder 301.

The component may also be pre-assembled prior to shipping to the drill site. In such embodiments, the sleeves may be press fit around the flanges. A grit may be placed into the press fit such that the grit may gall the surfaces of the flange and sleeve in order to create more friction between the two surfaces, wherein a stronger connection is made.

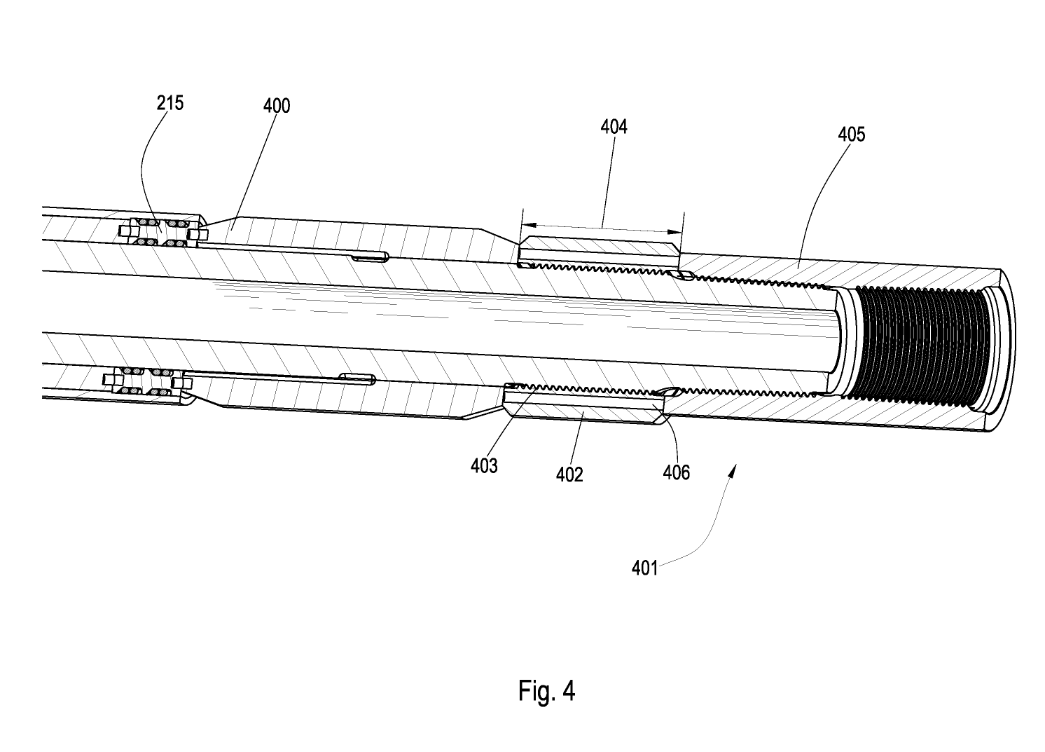

Referring now to FIG. 4, the fourth flange 215 on the component 200 may be keyed to a second shoulder collar 400 placed around a second end 401 of the component. The second shoulder collar 400 may also be keyed to the component in order to provide torsional support to the sleeves 203 and electronic equipment. A second left-threaded collar 402 may also be threaded onto a left-threaded portion 403 at the second end 401 of the component and keyed to the component to prevent axial displacement of other elements around the component. The second left-threaded collar 402 may be keyed to the second shoulder collar 400 by drilling holes 406 through a length 404 of the second left-threaded collar 402 and into the second shoulder collar 400 wherein pins 305 may be inserted. A female-female connector 405 may be threaded onto the second end 401 of the component such that the component comprises a box end and a pin end for linking multiple components together.

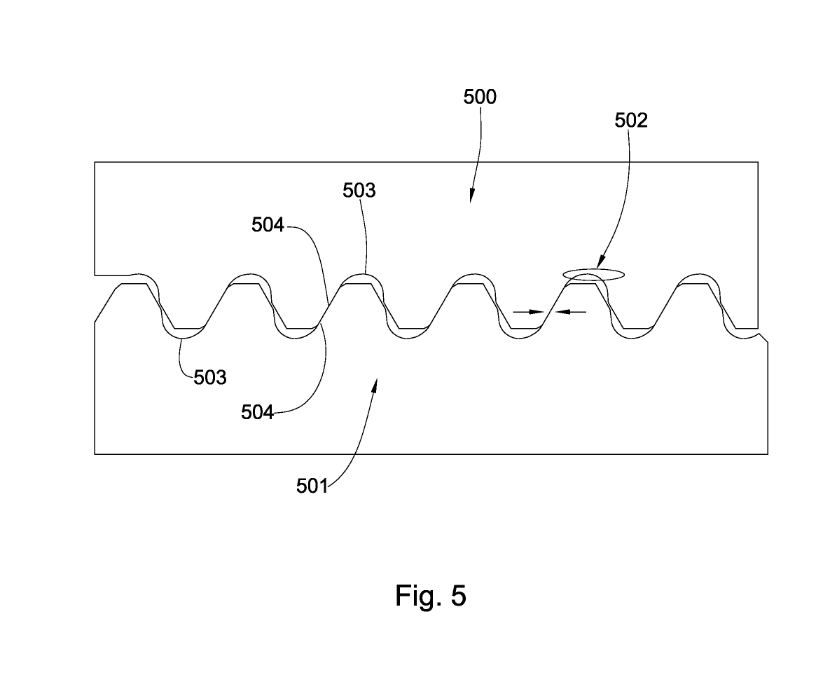

FIG. 5 discloses an internal threadform 500 joined with an external threadform 501 that may be used on the various threaded connections described above, on drill bit threads, tool string component threads, casing, or on other threaded connections in other applications. The load bearing flanks 504 are loaded against each other and produce a tensile load in a region 502 near the thread roots 503.

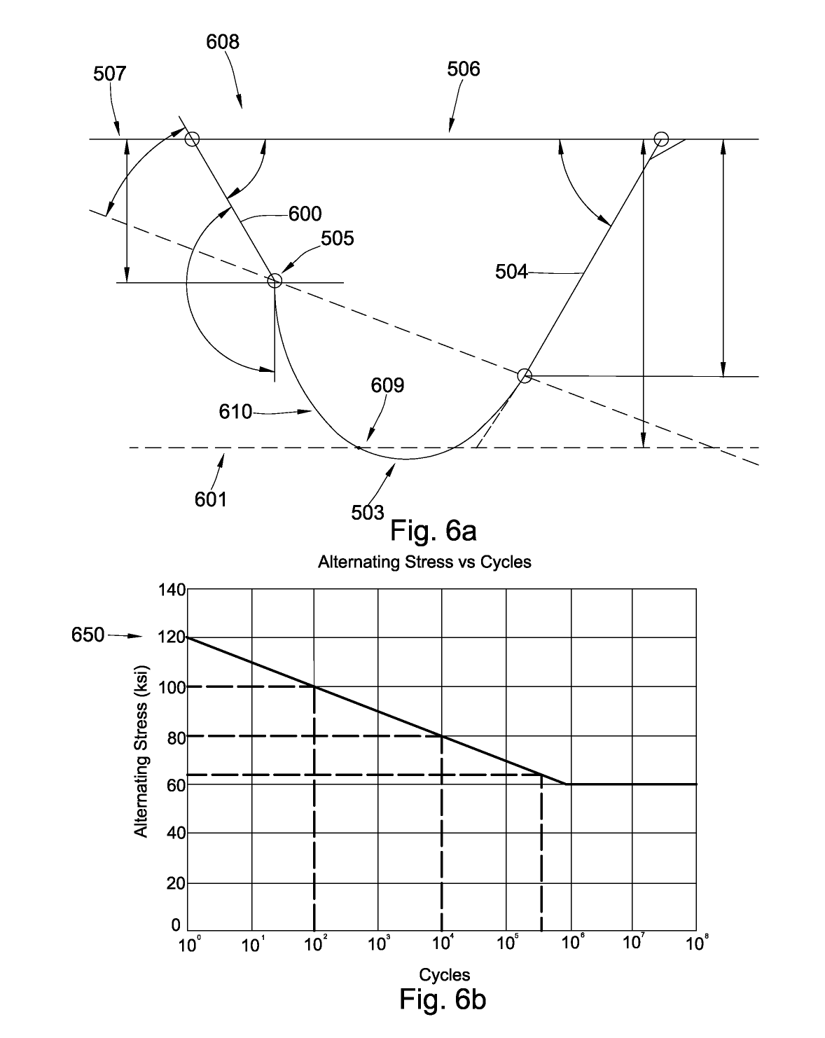

FIG. 6a discloses a preferred embodiment of a threadform 608. The load bearing flank 504 is joined to a non-load bearing flank 600 by a thread root 503 with a single, continuous curve 610. The load bearing flank is tangentially joined with the thread root 503, while the thread root joins the non-load bearing flank in a manner that forms an edge 505. The flanks may both form a 55 to 65 degree angle with a top elevation 506 of the each thread crests 507 or with a line 601 parallel with a central axis of the threadform. Preferably, the first and second angles are 60 degrees. In some embodiments, the flanks have substantially similar angles.

The thread root comprises a curve 610 defined by a non-conic section The curve has a constantly changing radius through out its length. The curve is sharpest between a midpoint 609 of the length of the curve and load bearing flank. Unlike a curve defined by an ellipse or circle, if curve 610 were to continue beyond the flanks, it would not produce a symmetric closed curve.

Unlike the teachings of U.S. Pat. No. 4,799,844; column 2, lines 23-30 and column 4, lines 34-68, where a larger radius of curvature is preferred for the deepest portion of a thread root, curve 610 comprises its sharpest portion at the deepest portion of the thread root. The radii of curvature increase towards the load bearing flank and the non-load bearing flank differently from the midpoint. From the midpoint the radii of curvature increase gradually towards the non-load bearing flank. From the midpoint to the load bearing flank, the radii of curvature decrease rapidly, then increase rapidly, followed by a gradual increase along the length of the curve.

Threadform 608 surprisingly yields a superior gradation of strain compared to conic transitions with resulting lower stress at the root of the thread over similar prior art threads.

FIG. 6b discloses a benefit of reducing the stress in a threadform. The non-conic section thread root reduces the stress of similar threads with curves defined with circles by 15 to 35 percent. The stress reduction was more significant for similar threadforms with curves formed by portions of ellipses. This stress reduction is significant as the diagram 650 of FIG. 6b illustrates. Steel threadforms with a reduced alternating stress from 100 ksi to 80 ksi tend to increase their life by 100 times. If that stress can be reduced further by another 20 percent to 64 ksi, the life of the threadform increases another 40 times. The relationship is logarithmic, so a small reduction in alternating stress substantially increases the life of the threadform.

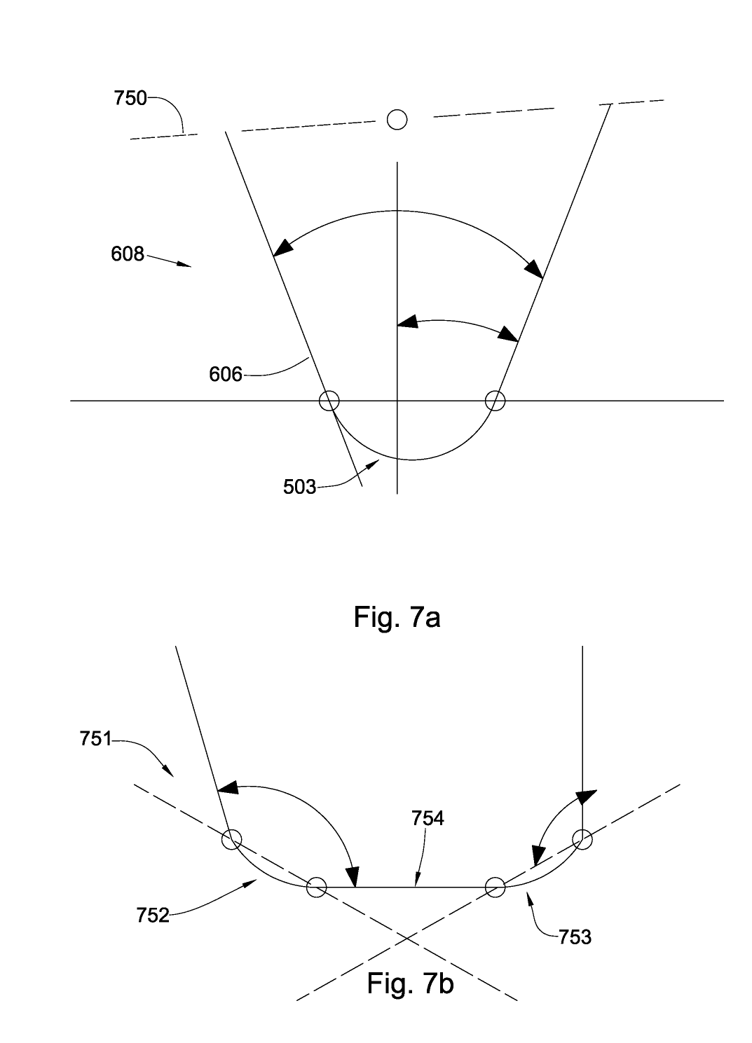

FIG. 7a discloses a threadform 608 with the thread root 503 tangentially joining the non-load bearing flank 600. The threadform is also an embodiment of a tapered thread incorporating the non-conic section thread root. Dashed line 750 illustrates the angle of the taper as defined by the crests of the thread.

FIG. 7b discloses a semi-buttressed threadform 751 with two separate non-conic section curves 752, 753. In some embodiments, a semi-buttressed threadform may comprise a single, continuous thread root joining the load bearing and non-load bearing flanks. In FIG. 7b's embodiment, the non-conic section curves are joined by a flat 754, but in other embodiments, curves 752 and 753 may be joined by another curve, a non-conic section curve, a conic section curve or combinations thereof.

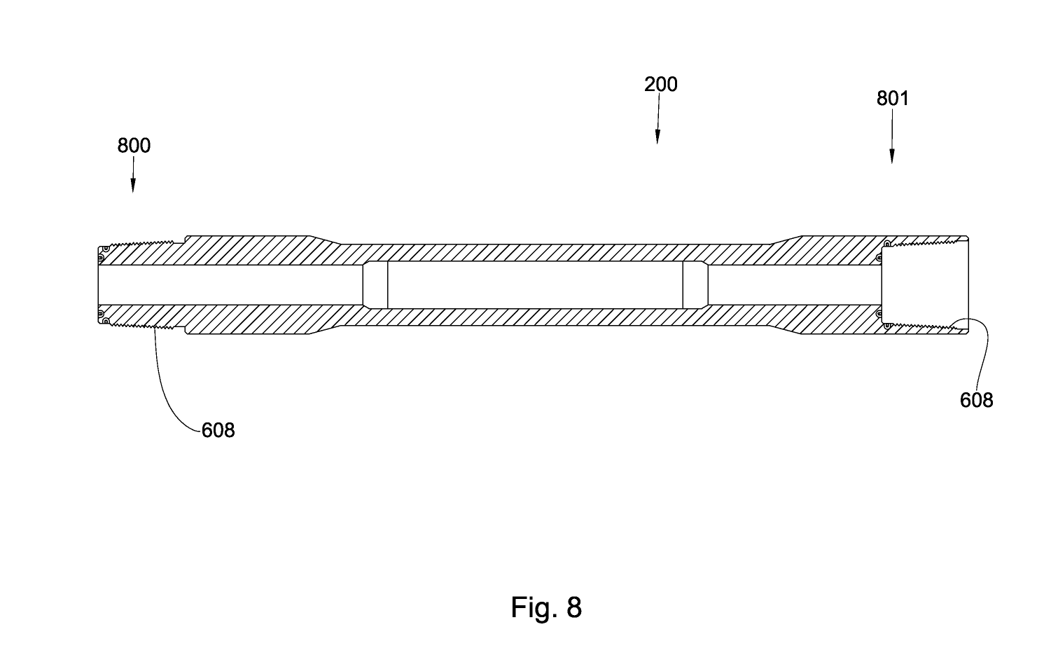

FIG. 8 discloses a threadform 608 on a pin end 800 and box end 801 of a downhole tool string component 200. Threadforms on both the internal box end and the external pin end are tapered.

Whereas the present invention has been described in particular relation to the drawings attached hereto, it should be understood that other and further modifications apart from those shown or suggested herein, may be made within the scope and spirit of the present invention.

What is claimed is:

1. A threadform, comprising:
a load bearing flank and a non-load bearing flank joined by a thread root;
the load bearing flank joins the thread root at a first angle and the non-load bearing flank joins the root to a second angle; and
the root comprising a single non-conic section curve.

2. The threadform of claim 1, wherein a sharpest section of the curve is between a midpoint of the curve and the load bearing flank.

3. The threadform of claim 1, wherein the curve comprises a constantly changing radius of curvature.

4. The threadform of claim 1, wherein the first angle is 55 to 65 degrees.

5. The threadform of claim 1, wherein the non-load bearing flank joins the root tangentially.

6. The threadform of claim 1, wherein the second angle is 55 to 65 degrees.

7. The threadform of claim 1, wherein the threadform is an internal or external thread form.

8. The threadform of claim 1, wherein the threadform is tapered.

9. The threadform of claim 1, wherein a sharpest portion of the thread root is a deepest portion of the root thread.

10. The threadform of claim 1, wherein the loading flanks tangentially joins the thread root.

11. A threadform formed on tool string component, comprising:
a load bearing flank and a non-load bearing flank joined by a thread root;
the load bearing flank tangentially joins the thread root at a first angle of 55 to 65 degrees and the non-load bearing flank joins the root at a second angle of less than 55 to 65 degrees; and
the root comprising an single non-conic curve.

12. The threadform of claim 11, wherein the threadform is formed proximate an end of the tool string component.

13. The threadform of claim 11, wherein the threadform is formed in between tool joints connected to ends of the tool string component.

14. The threadform of claim 11, wherein a sharpest section of the curve is between a midpoint of the curve and the load bearing flank.

15. The threadform of claim 11, wherein a sharpest portion of the thread root is a deepest portion of the root thread.

16. A threadform, comprising:
a load bearing flank and a non-load bearing flank joined by a thread root;
the load bearing flank joins the thread root at a first angle and the non-load bearing flank joins the root to a second angle; and
the root comprising at least one non-conic section curve.

17. The threadform of claim 16, wherein the threadform is a semi-buttressed threadform.

18. The threadform of claim 16, wherein the threadform is a tapered threadform.

19. The threadform of claim 16, wherein a sharpest portion of the thread root is a deepest portion of the root thread.

20. The threadform of claim 16, wherein at least two non-conic section curves are separated by a flat.
